(19) United States
(12) Patent Application Publication
(10) Pub. No.: US 2022/0073234 A1
(43) Pub. Date: Mar. 10, 2022

(54) Temperature activated unfolding structure for drinking straws and other enclosed containers

(71) Applicant: Richard Thomas Hale, III, New York, NY (US)

(72) Inventor: Richard Thomas Hale, III, New York, NY (US)

(21) Appl. No.: 16/974,020

(22) Filed: Sep. 9, 2020

(51) Int. Cl. B65D 25/00; B65D 43/16; A47G 21/18

(52) U.S. Cl. CPC B65D 25/005; F03G 7/065; A47G 21/18; B65D 43/16

(57) ABSTRACT

A machine for opening drinking straws and/or other enclosed containers using temperature changes. In the drinking straw variety, the straw is made in part or in full by Nitinol (also known as nickel titanium), Shape Memory Material, or similar such material that allows for the change in the straw's shape (known as the parent phase) in the elevated temperature of a dishwashing machine or similar machine using the Nitinol's or Shape Memory Material's reversible solid-state phase change (known as a martensitic transformation). When the straw is returned to room temperature, the straw closes to its original shape (known as its daughter phase) allowing it to be used as a standard straw. The container variety uses the same method but adapts it for container shapes. This phase change allows for lodged materials in the straw and/or container to be easily dislodged by the object opening in the dishwasher.

### CROSS REFERENCE TO RELATED APPLICATIONS

This application is based on provisional application Ser. No. 62/898,389, filed on Sep. 10, 2019.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of drinking straws and containers and more specifically to a temperature activated unfolding structure for drinking straws and other enclosed containers

In just the United States alone, one estimate suggests 500 million straws are used every single day. Most of these are of the plastic variety. Due to this large environmental problem, there has been a recent push to find more environmentally conscious solutions to this straw problem. Recently, many restaurants and bars have begun to ban disposable straw use in their establishments. Many consumers have also decided on using more permanent solutions than disposable plastic straws such as using straws made of metal, glass, wood, etc.

A problem with this solution is that these more permanent straws are not easily cleaned in dishwashing machines or other similar machines since they stay in a fixed shape when cleaning. Straws by their very shape and nature also comprise of a mostly enclosed compartment running down its length which is very difficult to clean by conventional means due to the fact that it is very difficult to reach.

One solution to this problem has been to use narrow and long pipe cleaners to run through the length of the straw. This solution, however, requires manually cleaning of each individual straw with a pipe cleaner which is not very practical or time efficient for many people to do every single time a straw needs cleaning. Additionally, the straw would not get as clean as if the straw's inner surface were more properly exposed to cleaning agents and water pressure in a dishwashing machine. Finally, even pipe cleaners are not fully able to clean all lodged materials inside the straw limiting the ability to clean the straw.

Given containers' enclosed shapes, they also face similar problems to straws in that things get lodged in them and are not easy to remove by dishwashing machines. Containers could also benefit from more easy access to its inner surface to allow for better cleaning and better access by the cleaning agents and water pressure in a dishwashing machine. Additionally, people do not always have the time or tools to dislodge any stuck material in the container to allow for cleaning each time they want to clean the container.

Therefore, there exists a need for a drinking straw and/or a container that is easy to clean in a dishwashing machine, automatically opens in a dishwashing machine for better cleaning, returns to its original shape at room temperature to be used as it was originally designed for, and also avoids all the steps currently necessary to clean the drinking straw and/or container thoroughly.

Straws and containers have been in use for thousands of years. American Marvin C. Stone patented the modern drinking straw, receiving the patent on Jan. 3, 1888 (U.S. Pat. No. 375,962A). Since then there has been relatively little innovation in the drinking straws regarding the ability to clean these straws making reusable straws not as clean as new straws. A constant problem with the drinking straw is that it is very difficult to clean due to its enclosed shape. The only attempts at making straws easier to clean have been through manually needing to open the straw and reclose it every time one needs to clean the straw (such as patent KR101763182B1). This option obviously has limited value and use due to the fact that it takes up a lot of time to clean each individual drinking straw. Similarly, using pipe cleaners every time one wants to clean the drinking straw also has limited use due to the fact that one needs to manually clean each time.

Similarly, enclosed containers suffer the same problems that drinking straws do in that things get lodged into the container and need manual cleaning to remove them. One solution has been the patent “Dual-capped hydration bottle” by David James Mayer (patent U.S. Pat. No. 8,365,941B2). This solution, however, is limited due to the fact that one needs to manually take on and take off the top or end caps of the bottle. Currently, there exists nothing that passively and automatically opens the drinking straw and/or container in the elevated temperature of the dishwashing machine or other similar machine. Similarly, there exists nothing that passively and automatically closes the drinking straw and/or container when the drinking straw and/or container returns to room temperature.

Additionally, there are no patents that use the shape change advantages of Nitinol, Shape Memory Material, or other similar materials to allow for better cleaning in a dish washing machine or other type machines for drinking straws or other enclosed containers.

### BRIEF SUMMARY OF THE INVENTION

The primary advantage of my invention is to provide a temperature activated unfolding structure for drinking straws and other enclosed containers that allows for stuck material to dislodge easily from the straw and/or container when the straw and/or container is being washed in a dishwashing machine or other similar machine.

Another advantage of my invention is to provide a temperature activated unfolding structure for drinking straws and other enclosed containers that allows a straw and/or container to not need to use a pipe cleaner brush to dislodge stuck material.

Another advantage of my invention is to provide a temperature activated unfolding structure for drinking straws and other enclosed containers that opens by itself to allow for easier cleaning when it is put in the elevated temperature of the dishwasher.

Another advantage of my invention is to provide a temperature activated unfolding structure for drinking straws and other enclosed containers that closes by itself to its original shape when the ambient temperature returns to room temperature so as to be useable again as a straw and/or container.
Other objects and advantages of the present invention will become apparent from the following descriptions, taken in connection with the accompanying drawings, wherein, by way of illustration and example, an embodiment of the present invention is disclosed.
In accordance with a preferred embodiment of the invention, there is disclosed a temperature activated unfolding structure for drinking straws and other enclosed containers comprising of a Straw Base (10), Straw Seam (20), Straw Wing (30), Straw Seal (40), Container Top (50), Container Bottom (60), Container Side (70), Container Seam (80), Container Seal (90), Container Hinge (100), Container Base (120).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

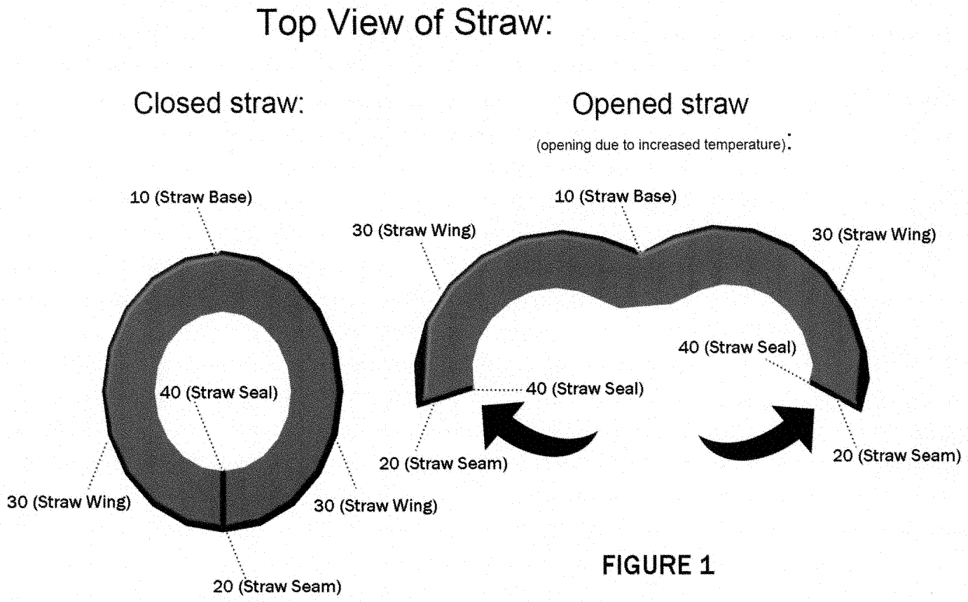

FIG. 1 is a top view of an embodiment of a straw of the present invention switching between its enclosed configuration at room temperature (known as the daughter phase) to its extended configuration (known as the parent phase) in the elevated temperature of a dishwashing machine or other similar machine.

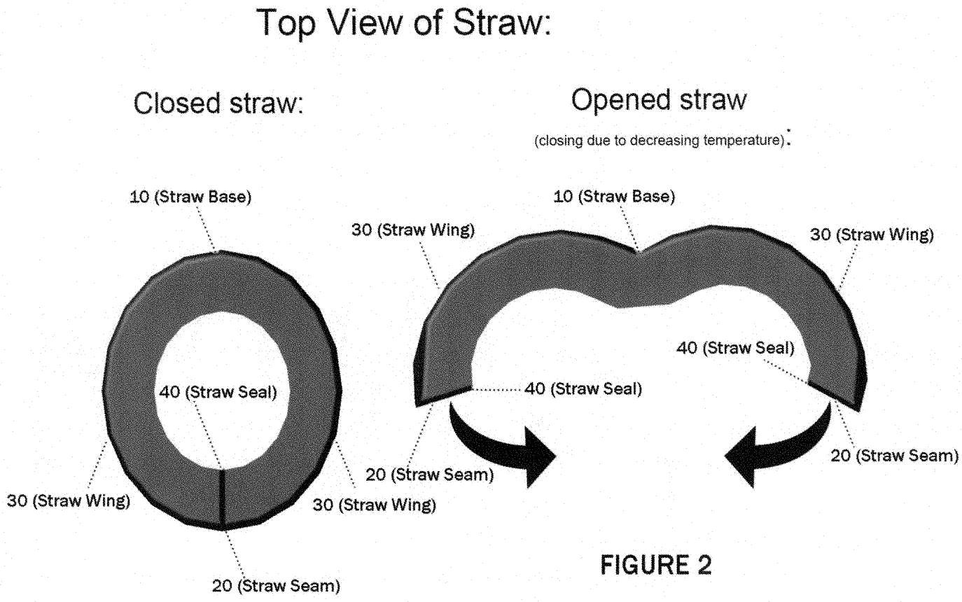

FIG. 2 is a top view of an embodiment of a straw of the present invention switching between its extended configuration in the elevated temperature of a dishwashing machine or other similar machine to its enclosed configuration at room temperature.

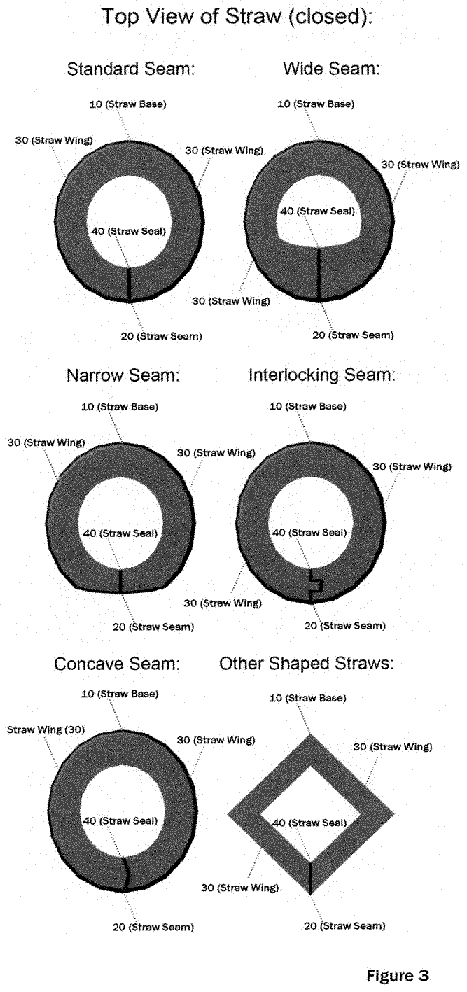

FIG. 3 is a top view of an embodiment of a straw of the present invention in a variety of different shapes in its enclosed configuration at room temperature.

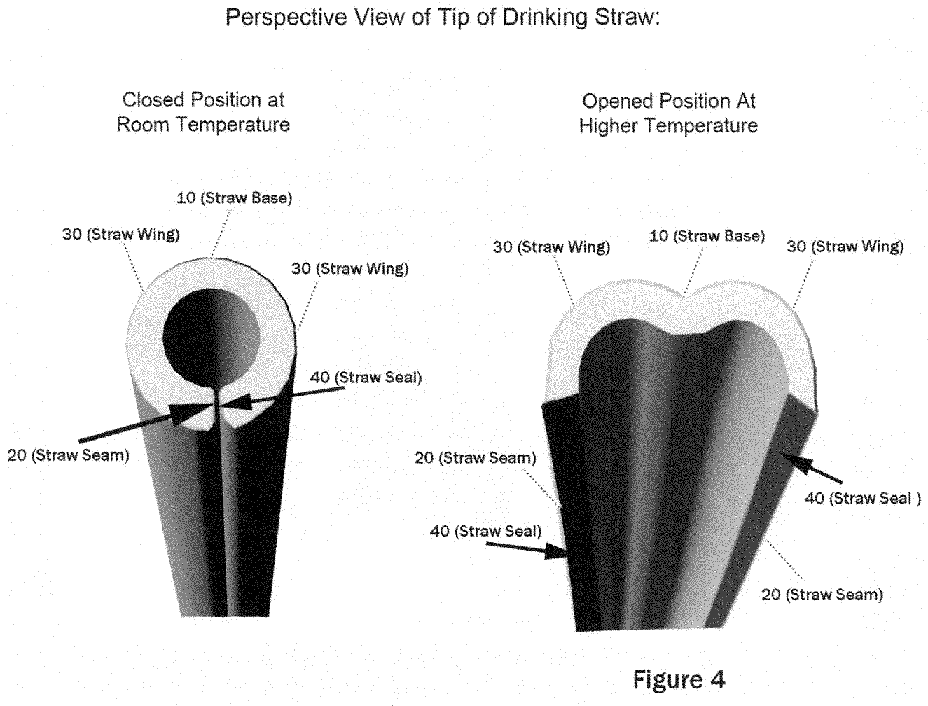

FIG. 4 is an upper perspective view of an embodiment of a straw of the present invention in its enclosed configuration at room temperature and its extended configuration in the elevated temperature of a dishwashing machine or other similar machine.

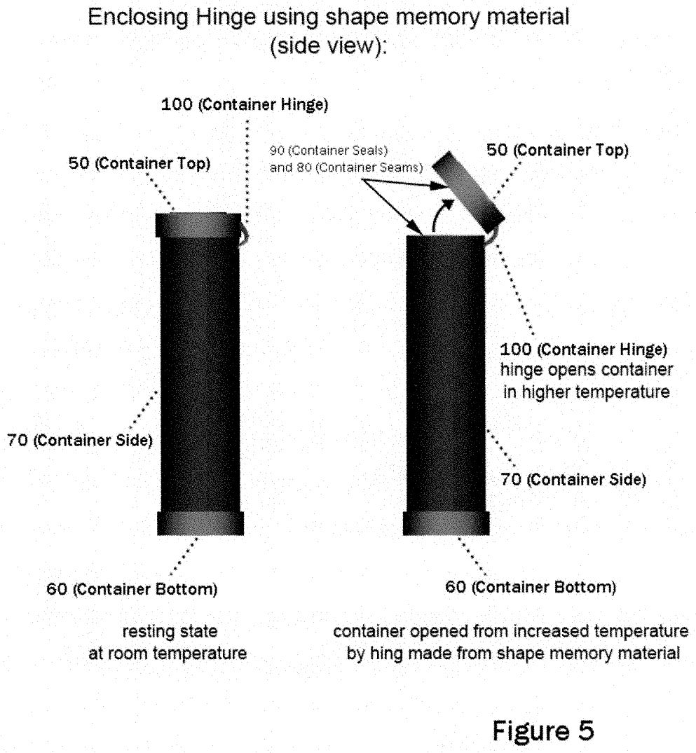

FIG. 5 is a side view of an embodiment of a container of the present invention in its enclosed configuration at room temperature and its extended configuration in the elevated temperature of a dishwashing machine or other similar machine.

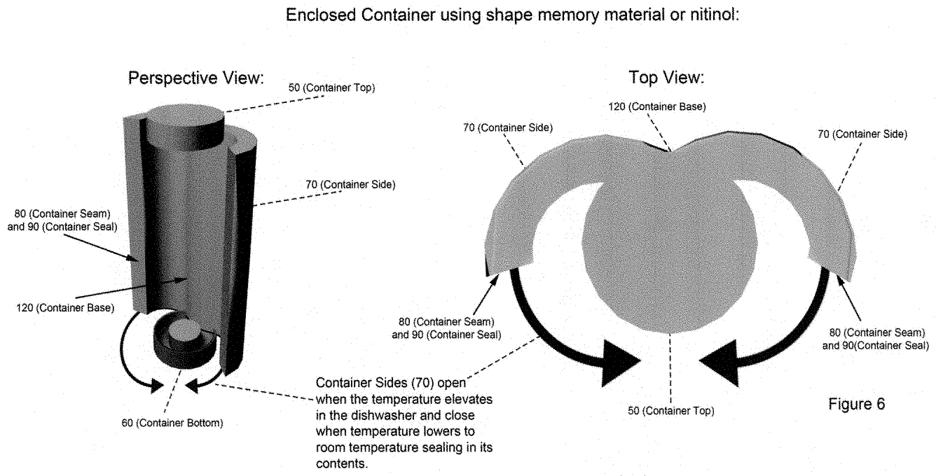

FIG. 6 is an upper perspective view and top view of an embodiment of a container of the present invention in its extended configuration in the elevated temperature of a dishwashing machine or other similar machine.

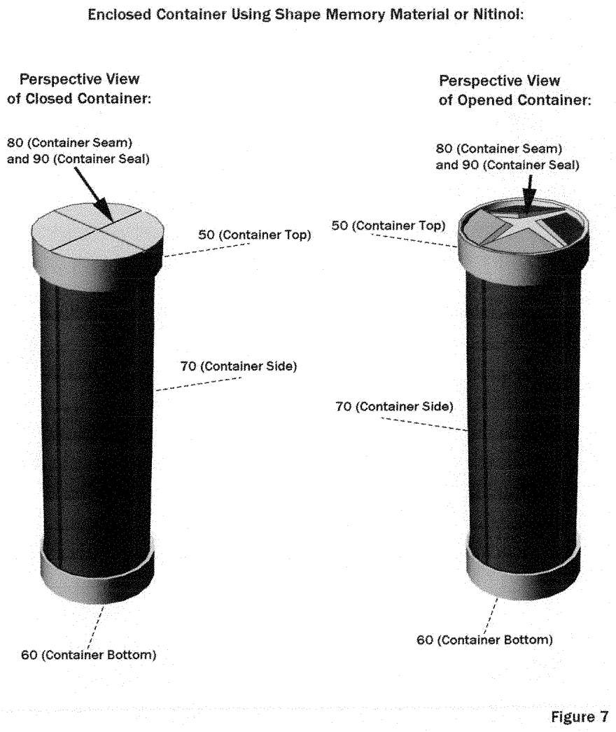

FIG. 7 is an upper perspective view of an embodiment of a container of the present invention in its enclosed configuration at room temperature and its extended configuration in the elevated temperature of a dishwashing machine or other similar machine.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Referring to FIG. 1, this is two top views of a straw which has a Straw Seam (20) down its side to allow for it to open. Due to the reversible solid-state phase change (known as a martensitic transformation) of either Nitinol metal or Shape Memory Material or other similar materials, the straw opens from an increase in temperature without human intervention (known as the parent phase) thereby allowing any lodged materials to be released and easily cleaned. This feature is useful to allow for straws to open so as to be cleaned in the higher temperature of a dish washer or other similar machine. The initial resting shape (known as the daughter phase) and the expanded shape of the straw (known as the parent phase) can be set during the initial manufacturing process for the straw.

As shown in FIGS. 1-4, in a preferred embodiment, the drinking straw includes a Straw Base (10), Straw Seam (20), Straw Wing (30), Straw Seal (40), The Straw Base (10) runs along the back of the straw longitudinally. The Straw Seam (20) runs longitudinally along the opposite side of the straw to the Straw Base (10). The straw is comprised of two Straw Wings (30). The Straw Wings (30) are attached to the Straw Base (10) and open outward in the elevated temperature of the dishwasher (the parent phase) to allow for any lodged materials to be removed. The Straw Wings (30) return to their original shape (the daughter phase) when returned to room temperature so that the drinking straw can be used as intended as a drinking straw. The Straw Wings (30) form the Straw Seam (20) when in the closed daughter phase of the drinking straw. The Straw Seal (40) can be added to the drinking straw to provide a better seal for the straw and allow for it to be airtight. The Straw Seal (40) is not always necessary but can help the straw be more airtight.

Referring to FIG. 2, this is two top views of a straw which shows the straw closing from a decrease in temperature. This drawing shows how the straw will return to its original shape (the daughter phase) after exiting from the higher temperatures of a dishwasher. This drawing shows that the straw will again return to its original shape (the daughter phase) so as to be useful as a straw.

Referring to FIG. 3, this drawing shows that this new technology can be used for all types of shapes of straws. The scope of the patent should not be limited to just these shapes but should indicate the different range of straws this technology can be applied to. The straws can be of different thicknesses. It also can have different shapes. The seam of the straw can also include different shapes to provide a better seal.

Referring to FIG. 4, this drawing is two upper perspective views of the straw. It shows the tip of the straw in its closed resting state (the daughter phase) at room temperature and its open state (the parent phase) in the higher temperature of a dishwasher.

Referring to FIG. 5, this is a side view of a container using the same technology as the straw. The Container's Top (50) and/or Container Bottom (60) automatically opens in an elevated temperature of a dishwasher to its parent phase to allow for easier washing due to the shape change of the Container Hinge (100) due to the Nitinol, Shape Memory Material or other such material that it is made from. The Container Top (50) and/or Container Bottom (60) then returns to its original shape (the daughter phase) when the Container Hinge (100) returns to room temperature thereby sealing the container without human intervention. The resting shape (daughter phase) and the elevated shape (the parent phase) are set during the manufacturing process. This technology does not need to be limited to containers that are cylindric in shape or enclosed on both the top and bottom but can be used for any type of enclosed container wherein the container automatic opening in a dishwasher or similar type of machine would be useful for better cleaning of the container. The Container makes use of Container Seals (90) to allow for a more air tight seal along the Container Seam (80) along the Container Top (50) and/or Container Bottom (60).

Referring to FIG. 6, this drawing is an upper perspective view of a container that uses this new technology for enclosing the side of a container and also a top view of the same container. The Container's Side (70) opens during the elevated temperature (the parent phase) of a dishwasher and closes when the container returns to room temperature (the daughter phase). The resting shape (the daughter phase) and the elevated shape (the parent phase) are set during the manufacturing process. Container Seals (90) running along the Container Seams (80) can also be utilized to provide a better, more airtight seal. This technology does not need to be limited to containers that are cylindric in shape or enclosed on both the top and bottom but can be used for any type of enclosed container wherein the container automatic opening in a dishwasher or similar type of machine would be useful for better cleaning of the container.

Referring to FIG. 7, this drawing is two views from the upper perspective of a container that uses this new technology for enclosing the Container Top (50) and/or Container Bottom (60). The Container's Top (50) opens during the elevated temperature of a dishwasher (the parent phase) and closes when the container returns to room temperature (the daughter phase). The resting shape (the daughter phase) and the elevated shape (the parent phase) are set during the manufacturing process. This technology does not need to be limited to containers that are cylindric in shape or enclosed on both the top and bottom but can be used for any type of enclosed container wherein the container automatic opening in a dishwasher or similar type of machine would be useful for better cleaning of the container. This shows just one of the possibilities that this new technology allows for. Different openings and different locations for the openings should also be covered and implied by this patent.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Temperature activated unfolding structure for drinking straws and other enclosed containers, the drinking straw comprising:
A Straw Base running down the length of the straw longitudinally, a Straw Seam running down the opposite side of the Straw Base allowing for opening and closing of the straw, Two Straw Wings making up the sides of the straw comprised of Nitinol, Shape Memory Material or other type of material to allow for the straw to automatically open in the elevated temperature of the dishwasher or other type machine and close again when returned to room temperature. The Straw Seal allows for better contact with the Straw Seam to allow for a better contact and to make it leak proof. The Straw Seal may not proof necessary in case the straw seals naturally.

2. Temperature activated unfolding structure for drinking straws and other enclosed containers, the enclosed container comprising:
The Container Side forms the side of the container. The Container Top forms the top of the container. The Container Bottom forms the bottom of the container. The Container Hinge attaches either the Container Top and/or Container Bottom to the Container Side. The Container Hinge is made up in whole or in part by Nitinol, Shape Memory Material or other similar material and allows for the Container Hinge to automatically open the Container Top and/or Container Bottom off of the Container Side in the elevated temperature of the dishwasher or other type machine. The Container Hinge also closes the container when the container returns to room temperature by returning the Container Top and/or Container Bottom to the Container Side. To help have a better seal and connection between the Container Top and/or Container Bottom when the container is closed, there may be Container Seams and Container Seals along the contact points between the Container Top and/or Container Bottom and the Container Side.

3. Temperature activated unfolding structure for drinking straws and other enclosed containers, the enclosed container comprising:
The Container Side forms the sides of the container. The Container Base forms the back of the Container Side running longitudinally down the Container Side. The Container Top forms the top of the container. The Container Bottom forms the bottom of the container. In this iteration of the container, as opposed to the Container Hinge changing shape as seen in claim 2, the Container Sides are comprised of Nitinol, Shape Memory Material or other type of material to allow for the sides of the container to automatically open up in the elevated temperature of the dishwasher. The Container Sides close when the container is returned to Room Temperature by returning the Container Sides to their original shape. The Container Sides then touch each other along the the Container Seam. To help have a better seal and connection between the Container Sides when the container is closed, there may be Container Seals along the contact points between the Container Top and/or Container Bottom and the Container Side.

4. Temperature activated unfolding structure for drinking straws and other enclosed containers, the enclosed container comprising:
The Container Side forms the sides of the container. The Container Top forms the top of the container. The Container Bottom forms the bottom of the container. In this iteration of the container, as opposed to the Container Side changing shape as seen in claim 3, the Container Top and/or Container Bottom are comprised of Nitinol, Shape Memory Material or other type of material to allow for the Container Top and/or Container Bottom to automatically open up in the elevated temperature of the dishwasher. The Container Top and/or Container Bottom close when the container is returned to Room Temperature by returning the Container Top and/or Container Bottom to their original shape. At room temperature, the Container Top and/or Container Bottom then close along the Container Seam. To help have a better seal and connection between the contact points in the Container Top and/or Container Bottom when the container is closed, there may be Container Seals along the contact points running within the Container Top and/or Container Bottom.
